(19) United States
(12) Patent Application Publication
(10) Pub. No.: US 2012/0237421 A1
(43) Pub. Date: Sep. 20, 2012

(54) Method for Removing CO2 From Exhaust Gases, Such as Exhaust Gases From Plants for Producing Raw Iron or Exhaust Gases From Syngas Plants

(76) Inventors: Robert Millner, Loosdorf (AT); Jan-Friedemann Plaul, Linz (AT); Johannes Leopold Schenk, Linz (AT); Kurt Wieder, Schwertberg (AT)

(21) Appl. No.: 13/395,508

(22) PCT Filed: Sep. 7, 2010
(86) PCT No.: PCT/EP10/63099

§ 371 Date: May 29, 2012

(30) Foreign Application Priority Data
Sep. 11, 2009 (AT) A1441/2009

(51) Int. Cl. B01D 53/62; B01D 53/74; C01B 31/20

(52) U.S. Cl. 423/229; 423/220; 423/232; 423/228; 423/437.1; 422/173

(57) ABSTRACT

A method for the removal of CO₂ from exhaust gases, e.g., exhaust gases from plants for pig-iron production or exhaust gases from synthesis-gas plants, includes removing CO₂ using chemical and/or physical absorption, wherein the heat for regenerating the absorbent is obtained at least partially from an air separation plant. As a result, the CO₂ can be separated from the exhaust gases to a greater extent than in the pressure-swing adsorption of other gases, but a lower-order energy carrier can additionally be used for this purpose.

### CROSS-REFERENCE TO RELATED APPLICATIONS

This application is a U.S. National Stage Application of International Application No. PCT/EP2010/063099 filed Sep. 7, 2010, which designates the United States of America, and claims priority to Austrian Patent Application No. A1441/2009 filed Sep. 11, 2009. The contents of which are hereby incorporated by reference in their entirety.

### TECHNICAL FIELD

This disclosure relates to methods for the removal of CO₂ from exhaust gases, such as exhaust gases from plants for pig-iron production or exhaust gases from synthesis-gas plants, and to a corresponding plant.

### BACKGROUND

For the production of pig iron, which is also to embrace the production of products similar to pig iron, there are essentially two known commonly adopted methods: the blast furnace method and melt reduction.

In the blast furnace method, first, pig iron is produced from iron ore with the aid of coke. Moreover, scrap may additionally be used. Thereafter, steel is produced from pig iron by means of further methods. The iron ore is mixed as lump ore, pellets or sinter together with the reducing agents (mostly coke, or else coal, for example in the form of a nutty slack injection plant) and with further constituents (limestone, slag-forming fluxes, etc.) into what is known as burden and is subsequently charged into the blast furnace. The blast furnace is a metallurgical reactor in which the burden column reacts in countercurrent with hot air, what is known as hot blast. The combustion and gasification of carbon from coke and coal give rise to the heat needed for the reaction and to carbon monoxide or hydrogen which constitutes an appreciable part of the reduction gas and which flows through the burden column and reduces the iron ore. Pig iron and slag occur as a result and are capped periodically.

In what is known as an oxygen blast furnace, which is also designated as a blast furnace with top-gas or blast-furnace gas recirculation, during the gasification of coke or coal oxygen-containing gas having an oxygen fraction (O₂) of more than 90% is injected into the blast furnace.

For the gas emerging from the blast furnace, what is known as top gas or blast-furnace gas, gas purification has to be provided (for example, dust separators and/or cyclones in combination with wet scrubbers, bag-filter units or hot-gas filters). Further, in the oxygen blast furnace, mostly a compressor, preferably with aftercooler, for the top gas recirculating into the blast furnace is provided, and also an apparatus for CO₂ removal, e.g., mostly by means of pressure-swing adsorption.

Further options for the design of a blast-furnace method are a heater for the reduction gas and/or a combustion chamber for partial combustion by oxygen.

Two disadvantages of the blast furnace are the requirements to be met by the materials used and the high carbon dioxide output. The iron carrier used and the coke have to be lumpy and hard, so that sufficient cavities remain in the burden column which may ensure that the injected blast flows through. The CO₂ output constitutes serious environmental pollution. There are therefore efforts to supersede the blast-furnace route. Mention may be made here of sponge-iron production based on natural gas (MIDREX, HYL, FINMET) and also the melt-reduction methods (Corex and Finex methods).

In melt reduction, a melt-down gasifier is used, in which hot liquid metal is produced, and also at least one reduction reactor in which the carrier of the iron ore (lump ore, fine ore, pellets, sinter) is reduced by means of reduction gas, the reduction gas being generated in the melt-down gasifier by means of the gasification of coal (and, if appropriate, a small fraction of coke) with oxygen (90% or more).

In the melt-reduction method, too, the following are typically provided:
gas purification plants (on the one hand, for the top gas from the reduction reactor and, on the other hand, for the reduction gas from the melt-down gasifier),
a compressor, preferably with aftercooler, for the reduction gas recirculated into the reduction reactor,
an apparatus for CO₂ removal, e.g., mostly by means of pressure-swing adsorption,
and, optionally, a heater for the reduction gas and/or a combustion chamber for partial combustion with oxygen.

The Corex process is a two-stage smelt-reduction method. Smelt-reduction combines the process of direct reduction (prereduction of iron into sponge iron) with a smelting process (main reduction).

The Finex method, likewise known, corresponds essentially to the Corex method, but iron ore is introduced as fine ore.

If the CO₂ output into the atmosphere during the production of pig iron is to be appreciably reduced, this should be separated from the exhaust gases arising from pig-iron production and stored in bound form (CO₂ capture and sequestration (CCS)).

The disclosure relates not only to pig-iron production, but also to synthesis-gas plants. Synthesis gases contain hydrogen and mostly also CO-containing gas mixtures which are to be used in a synthesis reaction. Synthesis gases may be produced from solid, liquid or gaseous substances. In particular, this includes coal gasification (coal is reacted with water vapor and/or oxygen to form hydrogen and CO) and the production of synthesis gas from natural gas (reaction of methane with water vapor and/or oxygen to form hydrogen and CO). In synthesis-gas plants, too, undesirable CO₂ occurs which it is expedient to separate.

For the separation of CO₂, pressure-swing adsorption (PSA), in particular also vacuum pressure-swing adsorption (VPSA), have hitherto been used primarily. Pressure-swing adsorption is a physical method for the selective decomposition of gas mixtures under pressure. Special porous materials (for example, activated silicon oxide (SiO₂), activated aluminum oxide (Al₂O₃), zeolites, activated charcoal or a combined use of these materials) are employed as a molecular sieve, in order to adsorb molecules according to their adsorption forces and/or kinetic diameter. In PSA, use is made of the fact that gases are adsorbed on surfaces to a differing extent. The gas mixture is introduced into a column under an exactly defined pressure. The undesirable components (here, CO₂ and H₂O) are then adsorbed, and the valuable substance (here, CO, H₂, CH₄) predominantly flows, unimpeded, through the column. As soon as the adsorbent is fully laden, the pressure is reduced and the column is scavenged. To operate a (V)PSA plant, electrical current may be required for compressing the CO₂-laden supply gas.

The product-gas stream after pressure-swing adsorption, which contains the valuable substances, also contains about 2-6% by volume of CO₂ in the case of exhaust gases from pig-iron production. However, the residual-gas stream from the (V)PSA plant still contains relatively high reducing gas constituents (for example, CO, H₂) which are lost for pig-iron production.

The residual-gas stream after pressure-swing adsorption, which contains the undesirable components, typically has, in the case of exhaust gases from pig-iron production, the following composition:

| | % by volume | % by volume |
|---|---|---|
| Compound | with VPSA | with PSA |
| H₂ | 2.2 | 5.5 |
| N₂ | 1.5 | 2.4 |
| CO | 10.9 | 16.8 |
| CO₂ | 82.1 | 72.2 |
| CH₄ | 0.7 | 0.9 |
| H₂O | 2.6 | 2.2 |

The residual gas cannot be utilized thermally in a simple way because, for this purpose, it would have to be enriched with other fuels on account of the low and/or fluctuating calorific value of about ±50%. It would also reduce the calorific value of the export gas (=that part of the top gas which is drawn off from the pig-iron production process) from pig-iron production if it were mixed with the top gas from the blast furnace or melt reduction, thus consequently also reducing the efficiency of a power station supplied with export gas, for example a combined-cycle power plant (CCPP) on account of the high fuel-gas compression and the lower efficiency of the gas turbine. In a steam power station or a heating boiler, the flame temperature during combustion would be reduced.

If the CO₂ is to be captured from the residual gas, the residual gas has to be compressed so that the CO₂ is typically present in liquid form, and subsequently the liquid CO₂ has to be introduced into a reservoir, for which purpose the pressure mostly has to be increased to an extent such that the CO₂ is in the liquid/solid or supercritical state where CO₂ has a density of about 1000 kg/m³.

The supercritical state is a state above the critical point in the phase diagram (see FIG. 1), which is characterized by the balancing of the densities of the liquid and gaseous phase.

The differences between the two states of aggregation cease to exist at this point.

For such high compression, a multi-stage compressor of high power has to be used in order to bring the typical densities to line level which is approximately in the range higher than 0° C. and higher than 70 bar (7,000,000 Pa), preferably at 80-150 bar at ambient temperatures.

However, the residual gas from a (V)PSA is not suitable to be captured, since it has, in addition to CO₂, a relatively high fraction of CO, H₂, N₂, CH₄, etc. On the one hand, the CO fraction constitutes a safety risk, since, in the event of leakage, it may cause a hazard to persons (CO poisoning) and, under certain circumstances, may lead to ignition or explosion. Further, the “impurities” CO, H₂, etc. of the CO₂ are lost for energy recovery or reduction work and influence the physical properties of the compressed gas which, on account of the fluctuating fractions of CO, H₂, etc., likewise fluctuate and cause measurability, compression, water-solubility and transport properties to fluctuate.

Owing to the impurities, the distances between the stations where the transported liquefied gas mixture has to be compressed anew also have to be reduced, with the result that the operating costs rise because of additional compressors or pumps and their energy requirement. Or the inlet pressure in the line has to be increased in order to reduce the number or power of the additional pumps and compressors along the line. Investigations regarding the influence of impurities upon the transport of liquefied gases have been conducted by Newcastle University and published under http://www.geos.ed.ac.uk/ccs/UKCCSC/Newcastle 2 07.ppt. A diagram of this is illustrated in FIG. 2.

### SUMMARY

In one embodiment, a method for the removal of CO2 from exhaust gases, such as exhaust gases from plants for pig-iron production or exhaust gases from synthesis-gas plants, includes removing the CO2 by means of chemical and/or physical absorption, the heat for regenerating the absorbent being obtained at least partially from an air separation plant.

In a further embodiment, the absorbent used is potassium carbonate. In a further embodiment, the method includes an amine scrub. In a further embodiment, primary amines, such as methylamine, monoethanolamine (MEA) and/or diglycolamine (DGA), are used. In a further embodiment, secondary amines, such as diethanolamine (DEA) and/or diisopropanolamine (DIPA), are used. In a further embodiment, tertiary amines, such as triethanolamine (TEA) and/or methyldiethanolamine (MDEA), are used. In a further embodiment, top gas from a blast furnace, in particular from an oxygen blast furnace with top-gas recirculation, is purified of CO2. In a further embodiment, exhaust gas from a melt-reduction plant is purified. In a further embodiment, at least one of the following exhaust gases is purified: exhaust gas from a melt-down gasifier, exhaust gas from at least one reduction reactor, and exhaust gas from at least one solid-bed reactor for the preheating and/or reduction of iron oxides and/or iron briquettes. In a further embodiment, at least part of the purified exhaust gas is used again as a reduction gas for pig-iron production. In a further embodiment, hot air or a heat transfer medium from the air separation plant is conducted into a heat exchanger for heating and regenerating the absorbent. In a further embodiment, hot air from the main air compressor and/or from the booster air compressor or its waste heat is used by means of a heat transfer medium. In a further embodiment, the CO2-rich gas obtained from the CO2 removal process is used as a substitute gas in the iron production process or for the treatment and storage of CO2.

In another embodiment, an apparatus includes a plant for implementing a method for the removal of CO2 from exhaust gases, such as exhaust gases from plants for pig-iron production or exhaust gases from synthesis-gas plants, including removing the CO2 by means of chemical and/or physical absorption, the heat for regenerating the absorbent being obtained at least partially from an air separation plant. The plant part for regenerating the absorbent is connected to an air separation plant such that the heat generated therein can be used at least partially for regenerating the absorbent.

In a further embodiment, a line is provided, by means of which top gas from a blast furnace, in particular from an oxygen blast furnace with top-gas recirculation, can be conducted into the plant for the removal of CO2 by means of chemical and/or physical absorption. In a further embodiment, at least one line is provided, by means of which exhaust gas from a melt-reduction plant can be conducted into the plant for the removal of CO2 by means of chemical and/or physical absorption. In a further embodiment, at least one of these lines is connected to at least one of the following devices: to a melt-down gasifier, to one or more reduction reactors, and to a solid-bed reactor for the preheating and reduction of iron oxides and/or iron briquettes. In a further embodiment, a line is provided, by means of which at least part of the purified exhaust gas can be conducted back again as a reduction gas for pig-iron production. In a further embodiment, at least one line is provided, by means of which hot air or another heat transfer medium from the air separation plant is conducted into a heat exchanger for heating and regenerating the absorbent. In a further embodiment, at least one line is provided, by means of which hot air or another heat transfer medium from the main air compressor and/or from the booster air compressor can be conducted into the heat exchanger. In a further embodiment, the plant for the removal of CO2 by means of chemical and/or physical absorption is connected to a plant for pig-iron production and/or to a plant for the treatment and storage of CO2, such that the CO2-rich gas obtained can be used as a substitute gas in the iron production process and/or for the treatment and storage of CO2.

### BRIEF DESCRIPTION OF THE DRAWINGS

Example embodiments will be explained in more detail below with reference to figures, in which:

FIG. 1 shows a phase diagram of CO₂.

FIG. 2 shows the relation between impurities of gases and the compression stations used for this purpose during the transport of liquefied gases.

FIG. 3 shows the connection between a blast furnace and an air separation plant, according to certain embodiments.

FIG. 4 shows the connection between a plant for melt reduction and an air separation plant, according to certain embodiments.

### DETAILED DESCRIPTION

Some embodiments relate to methods for separating CO₂ from exhaust gases of pig-iron production or synthesis-gas production to a greater extent than in the (V)PSA of other gases, but additionally to use for this purpose a lower-order energy carrier than in (V)PSA.

Thus, some embodiments provide a method in which the CO₂ is removed by means of chemical and/or physical absorption, the heat for regenerating the absorbent being obtained at least partially (preferably completely) from an air separation plant.

An “air separation plant” is understood to mean a plant in which air is first compressed, liquefied and subsequently separated into individual constituents (oxygen, nitrogen, noble gases).

Using a chemical and/or physical absorption process, the fractions of the gases CO, H₂, CH₄ recovered for pig-iron production can be increased, as compared with (V)PSA, and the CO₂ fraction in the product gas can be reduced appreciably (to a few ppmv).

The use of waste heat from an already existing plant, here an air separation plant, may be more cost-effective than the generation of steam by means of a specific assembly solely for desorption. Moreover, the use of a low-order energy carrier, such as hot air, may be preferred over a high-order energy carrier, such as steam, for economic and ecological reasons. The extraction of heat from a running air separation plant may be, moreover, possible in a more flexible way than the generation of steam in a steam generator operated specifically for CO₂ removal. Further, an air separation plant may possess very high availability which may be above that of a pig-iron production plant.

The combination of an air separation plant, on the one hand, and pig-iron or synthesis-gas production, on the other hand, may also be advantageous because the oxygen separated in the air separation plant can be used in pig-iron or synthesis-gas production.

The residual-gas stream after chemical and/or physical absorption mainly contains CO₂ and, after the removal of H₂S, only traces of H₂S and can therefore be discharged directly into the atmosphere and/or even be delivered for CO₂ compression with subsequent CO₂ storage (sequestration, for example EOR—enhanced oil recovery, EGR—enhanced gas recovery) and/or, however, also be used as a substitute for N₂ in iron production and coal gasification: the residual-gas stream consists mainly of CO₂ and can therefore be used for charging devices, barrier seals and selected scavenging-gas and cooling-gas consumers.

On account of the low content of impurities, the energy outlay for compressing the residual-gas stream from chemical and/or physical absorption into the liquid/solid or supercritical state (>73.3 bar) may be about 20-30% lower than for residual gas from (V)PSA. Consequently, the distances between the stations where the gas has to be compressed anew may also be increased in the gas lines. Both the procurement costs and the operating costs for CO₂ treatment may thereby be lowered.

In comparison with pressure-swing adsorption, chemical and/or physical absorption may operate with lower pressures in the case of the gas to be purified and with a lower pressure drop in the removal of the CO₂, so that energy may be saved here, too. In contrast to VPSA, there may also be no need for vacuum compressors which likewise consume a large amount of energy. The low energy consumption may be an advantage, above all, for those countries where energy is scarce and/or costly.

Owing to the then higher fraction of combustible substances in the exhaust gas, purified according to certain embodiments, from pig-iron production or synthesis-gas production, the plant capacity can be increased or its specific consumption values lowered or else, in the combustion of this gas in a power station, a higher efficiency of the power station may be implemented.

The investment costs for a chemical and/or physical absorption method may be comparable to those for a VPSA plant. However, the absorption method may need large quantities of heat. This heat may be costly if it had to be produced specifically and possibly could not be provided by an already existing heat source.

Chemical absorption methods may be distinguished in that the gas to be separated makes a firm or loose chemical bond with the absorbent partially to completely. In a physical absorption method, the gas to be separated is dissolved, without any variation of its material properties, in the absorbent, the Van der Waals forces taking effect. Furthermore, there are also methods in which both chemical and physical binding forces are employed and which are designated as hybrid scrubbing.

Various chemical absorption methods may be suitable for certain embodiments:

A first example absorption method is characterized by the use of potassium carbonate as absorbent. Hot potassium carbonate is used (HPC or “Hot Pot”). Depending on the provider of this method, various substances are admixed to the potassium carbonate: activators which are to increase the CO₂ separation and inhibitors which are to reduce corrosion. A method of this type in widespread use is known by the name of the Benfield method and is provided by UOP. In the Benfield method, about 0.75 kg of steam per Nm³ of gas to be purified is typically required.

A second example absorption method is known as amine scrub with a plurality of method steps. In this case, in a first step, slightly alkaline aqueous solutions of amines (mostly ethanolamine derivatives) are employed which chemically absorb the acid gases, that is to say, for example, the CO₂, reversibly. In a second method step, the acid gas is separated from the amine again thermally (by heating), and the recovered amine is used anew for the scrub.

Known methods in this regard include the Amine Guard FS method of UOP, which performs a reduction of the CO₂ content to 50 ppmv and of the H₂S content to 1 ppmv. The steam requirement of this method is about 1.05 kg of steam per Nm³ of gas to be purified.

Amines, for example diethanolamine (DEA), may also be used as activators for absorption methods, using potassium carbonate, for example for the Benfield method.

For the amine scrub, primary amines may be employed, such as methylamine, monoethanolamine (MEA) and/or diglycolamine (DGA).

For the amine scrub, secondary amines, for example diethanolamine (DEA) and/or diisopropanolamine (DIPA), may be used additionally or alternatively to primary amines.

Additionally or alternatively to primary and/or secondary amines, tertiary amines may also be used, for example triethanolamine (TEA) and/or methyldiethanolamine (MDEA). An existing method in this regard is the aMDEA method of the company BASF (provided by Linde and Lurgi), which uses activated methyldiethanolamine (MDEA). The steam requirement of this method may be about 0.85 kg of steam per Nm³ of gas to be purified.

There are also various physical absorption methods which may be suitable for certain embodiments, some of the most important representatives being what are known as the Purisol® method, Rectisol® method and the Selexol method.

In the Purisol® method, N-methyl-2-pyrrolidone (NMP) is used as absorbent, and the regeneration of the absorbent takes place by means of steam via indirect heat exchangers, the steam requirement being about 1417 kg/MM scf=approx. 0.050 kg/Nm³. All suitable types of heat exchange media may in this case be used: e.g., air, nitrogen, steam, thermal oil, etc.

In the Rectisol® method, cooled methanol (CH₃OH) is employed as absorbent. The regeneration of the absorbent takes place by means of steam via indirect heat exchangers, the absorbent being heated only to approximately 65° C. The heat requirement may be about 1157 kg/MM scf=approx. 0.041 kg/Nm³ of gas to be purified. All suitable types of heat exchange media may in this case be used: e.g., air, nitrogen, steam, thermal oil, etc.

In the Selexol method, a mixture of dimethylethers of polyethylene glycol is used as absorbent. Regeneration takes place by means of steam, wherein a direct contact of the absorbent with steam or with an inert gas (for example, nitrogen) may be necessary.

By means of the method according to certain embodiments, advantageously top gas from a blast furnace, e.g., from an oxygen blast furnace with top-gas recirculation, which is operated predominantly with oxygen, instead of hot blast, can be purified of CO₂.

The method according to certain embodiments may be employed in the case of exhaust gases from melt-reduction plants, preferably for the CO₂ purification of at least one of the following exhaust gases:
exhaust gas (what is known as excess gas) from a melt-down gasifier,
exhaust gas from at least one reduction reactor,
exhaust gas (what is known as top gas) from at least one solid-bed reactor for the preheating and reduction of iron oxides and/or iron briquettes.

In order to utilize better the reducing constituents of the gas after CO₂ removal for pig-iron production or synthesis-gas production, there may be provision for at least part of the purified exhaust gas to be used again as a reduction gas for pig-iron production.

The energy necessary for regenerating the absorbent may be generated in that hot air from the air separation plant is conducted into a heat exchanger for heating and regenerating the absorbent. For example, hot air from the main air compressor and/or from the booster air compressor may be used. The heat from the air separation plant may also be made available for the regeneration of the absorbent by means of a heat transfer medium (for example, water vapor) which is heated by hot air from the air separation plant (from the main air compressor and/or the booster air compressor). The heat transfer medium may in this case be routed, for example, in a closed loop.

In an apparatus corresponding to the method according to certain embodiments, a plant for the removal of CO₂ by means of chemical and/or physical absorption may be provided, the plant part for regenerating the absorbent being connected to an air separation plant such that the heat generated therein can be used at least partially for regenerating the absorbent.

In particular, for the blast-furnace method, a line may be provided, by means of which top gas from a blast furnace, in particular from an oxygen blast furnace with top-gas recirculation, can be conducted into the plant for the removal of CO₂ by means of chemical and/or physical absorption.

In a melt-reduction method, at least one line would then be provided correspondingly, by means of which exhaust gas from a melt-reduction plant can be conducted into the plant for the removal of CO₂ by means of chemical and/or physical absorption.

At least one of these lines may be connected to at least one of the following devices:
to a melt-down gasifier,
to one or more reduction reactors,
to a solid-bed reactor for the preheating and/or reduction of iron oxides and/or iron briquettes.

In a further embodiment, a line is provided, by means of which at least part of the purified exhaust gas can be conducted back again as a reduction gas for pig-iron production.

Further, at least one line may be provided, by means of which hot air from the air separation plant, in particular from the main air compressor and/or the booster air compressor, is conducted into a heat exchanger for heating and regenerating the absorbent.

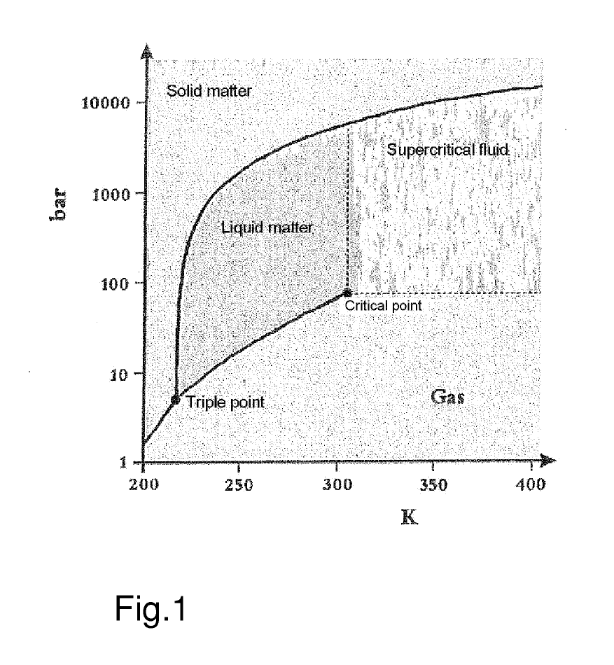

FIG. 1 illustrates a phase diagram of CO₂. The temperature is plotted in K on the horizontal axis and the pressure is plotted in bars (1 bar=10⁵ Pascal) on the vertical axis. The individual states of aggregation (solid matter or solid, liquid matter or liquid and gas or gaseous) are separated from one another by lines.

The triple point is that point where the solid, liquid and gaseous phases meet.

The supercritical state (supercritical fluid) is a state above the critical point in the phase diagram which is identified by the balancing of the densities of the liquid and gaseous phase. The differences between the two states of aggregation cease to exist at this point.

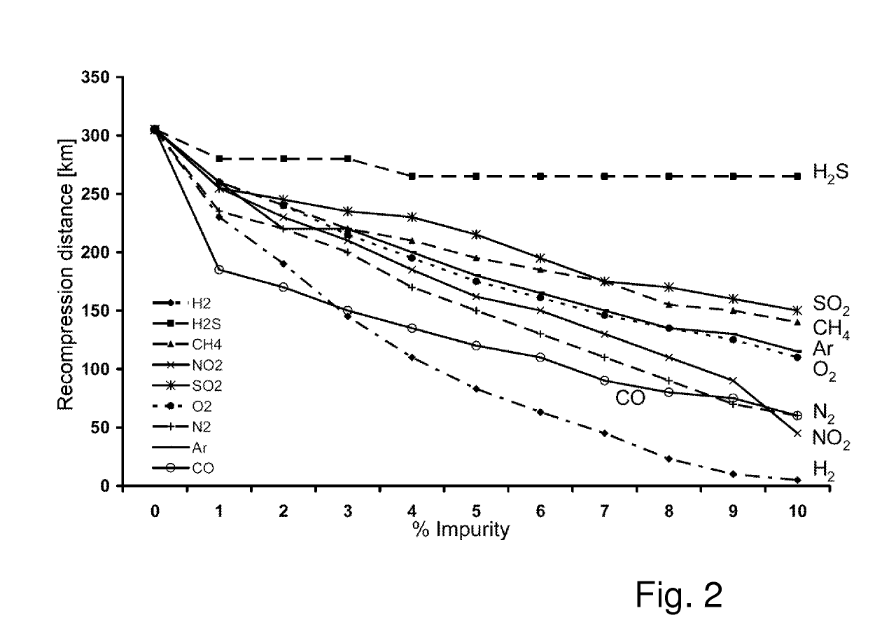

FIG. 2 illustrates the relation between impurities of gases and the compression stations used for this purpose during the transport of liquefied gases. The impurities are plotted in % of the gas volume on the horizontal axis, and the distance between the compressor stations is plotted in km on the vertical axis. A specific curve is depicted for each impurity.

With a 10% impurity (right-hand margin of the illustration), there is the least influence exerted on the distance between the compressor stations in the case of H₂S, followed by SO₂, CH₄, Ar, O₂, N₂ and CO equally, then NO₂, the greatest influence being had by H₂, where the curve almost approaches zero.

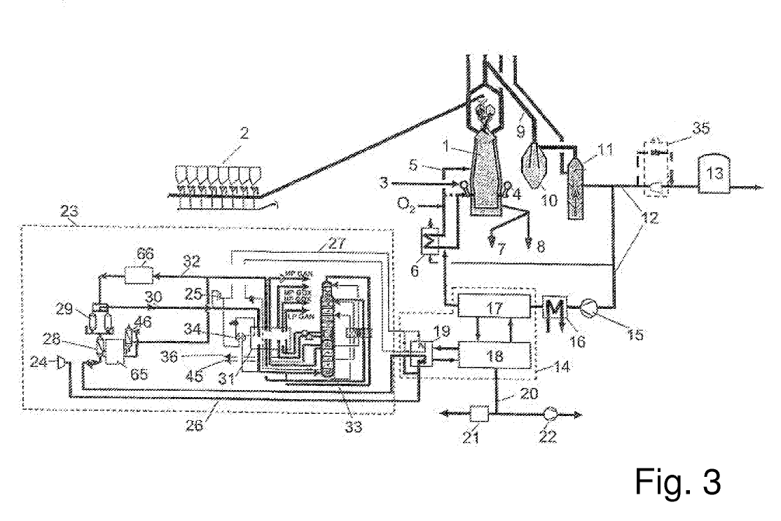

FIG. 3 illustrates an example oxygen blast furnace 1 with top-gas recirculation, which is supplied with iron ore from a sintering plant 2 and with coke (not illustrated), according to certain embodiments. Oxygen-containing gas 3 with an oxygen content>80% is introduced into the ring line 4, reduction gas 5 heated in the reduction-gas furnace 6 is likewise introduced, together with cold or preheated oxygen O₂, into the blast furnace 1, and slag 7 and pig iron 8 are drawn off at the bottom. On the top side of the blast furnace 1, the top gas or blast-furnace gas 9 is extracted and prepurified in a dust separator or cyclone 10 and purified again in a wet scrubber 11 (or a bag filter or hot-gas filter system). The top gas or blast-furnace gas 9 thus purified may, on the one hand, be extracted directly as export gas 12 from the blast-furnace system and supplied to an export-gas container 13 and, on the other hand, be supplied to a plant 14 for the chemical absorption of CO₂, the purified top gas or blast-furnace gas 9 previously being compressed (to about 2-6 barg (depending on the blast-furnace gas pressure)) in a compressor 15 and being cooled to about 30-60° C. in an aftercooler 16.

The plant 14 for the chemical absorption of CO₂ may consist essentially of an absorber 17 and of a stripper 18. Conventional plants of this type are known and will therefore be described here only in broad outline. In the absorber 17, the top gas or blast-furnace gas 9 to be purified is introduced from the bottom, while a solution, for example an amine solution, absorbing the acid constituents of the gas (essentially CO₂, H₂S) flows from the top downwards. Here, then, the CO₂ may be removed from the top gas or blast-furnace gas, and the purified gas may be supplied to the blast furnace 1 again.

The laden absorbent is conducted into the stripper 18 from above. In the lower region, the absorbent liquid is acted upon via an indirect heat exchanger with hot air of approximately 250-300° C. or steam from the air separation plant 23 and is heated to >100° C., in particular 110-120° C., with the result that the acid gases, in particular the CO₂, are released again as residual gas 20. The residual gas 20 may either be discharged into the atmosphere again after H₂S purification 21 and/or be delivered to a further compressor 22 for the liquefaction of CO₂, in order then to conduct it further on and, for example, store it underground, or in order to use it as a substitute for nitrogen in iron production or coal gasification, for example for charging devices, barrier seals and selected scavenging-gas and cooling-gas consumers.

The pressure-energy content of the export gas 12 may also be utilized in an expansion turbine 35 (top gas pressure recovery turbine) which, in this example, is arranged upstream of the export-gas container 13.

The heat for regenerating the absorbent in the stripper 18 is generated in a heat exchanger 19 which is fed with one or two hot-gas streams from an air separation plant 23: one gas stream 26 comes from the main air compressor 24 and has a pressure of approximately 4-12 bar_{g}, in particular of about 5 bar_{g}, and a temperature of about 280° C.; a second gas stream 27 comes from the booster air compressor 25 and has a pressure of 5 to 25 bar_{g}, in particular of 23 bar_{g}, and a temperature of approximately 200° C. Alternatively, heat exchange from hot air to an alternative heat transfer medium (for example, water/steam, thermal oil, nitrogen) may also take place first, and then from the heat transfer medium to the absorption liquid.

The main air compressor 24 sucks in ambient air which has a temperature of about 20° C. and atmospheric pressure. It consists of approximately 77% nitrogen, of approximately 21% oxygen, of approximately 1% water vapor and approximately 0.9% argon. Downstream of the main air compressor 24, the air has a temperature of about 280° C. and a pressure of about 5.2 barg. In the heat exchanger 19, the air from the air separation plant 23 is cooled to about 180° C.

By means of an air separation plant 23, air can be separated into its constituents. Air is a gas mixture of nitrogen (78%), oxygen (21%), argon (0.9%) and further noble gases. First, the air is liquefied and then separated into its constituents by means of rectification. Since these methods have already been known for a long time, they are to be described here only in broad outline, insofar as they are incorporated in certain embodiments.

In a first step, the air sucked in from the surroundings is first compressed in the main air compressor 24 to approximately 5.2 barg, with the result that the air is heated to about 280° C. This gas stream 26 or an alternative heat transfer medium is then conducted, according to certain embodiments, into the heat exchanger 19 of the plant 14 for the chemical absorption of CO₂, where it heats the absorption liquid.

In addition to the main air compressor 24, a booster air compressor 25 may be provided, which further compresses a part-stream (30-60%) of the air stream 30 compressed in the main air compressor 24 and purified in the scrubbing tower 28 and adsorber 29, for example to approximately 23 bar_{g}, with the result that the air is heated to about 200° C. The air compressed by the booster air compressor 25 is not immediately delivered entirely to the cold box 31, but, instead, according to certain embodiments, at least part 27 is first supplied to the heat exchanger 19 where it discharges heat for heating the absorption liquid. The other part is compressed via a turbine-operated compressor 34 and then supplied to the cold box 31, part (about 3-12% of the main air quantity) of the cooled air also being recirculated out of the cold box 31 to the compressor 34 again.

In conventional air separation, the air 26 compressed in the main air compressor 24 is delivered directly for purification, but in certain embodiments of the present disclosure the air cooled in the heat exchanger 19 is precooled in a scrubbing tower 28 by water and in an adsorber 29 is freed of impurities, such as dust, carbon dioxide, water vapor and hydrocarbons.

The air stream 30 purified in this way is then delivered to what is known as the cold box 31, a heat exchanger in which the air stream 30 is cooled further by colder air 32 from the rectification column 33. This is because it is only by compression in the main air compressor 24 and precooling in the scrubbing tower 28 that temperature ranges in which the air becomes liquid (−191 to −193° C.) are not reached. For this purpose, already depressurized gas streams, for example nitrogen 32 from the rectification column 33, have to be used for cooling the compressed purified air 30. This air 30 consequently reaches a temperature of about −180° C. During subsequent depressurization in an expansion valve or in an expansion turbine 34, it is finally cooled decisively and partially liquefied.

The liquefied air is conducted into the rectification column 33 where, for the separation of the liquefied air, the different boiling points of its constituents are utilized. The same principle as in alcohol distillation is involved here. Since the boiling points lie relatively closely to one another (oxygen −183° C., nitrogen −196° C.), distillation has to be carried out in a multi-stage process in this rectification column 33: the liquid air trickles downwards over a number of sieve plates in countercurrent to the non-liquefied rising air. The liquid is dammed on the sieve plates and rising steam bubbles flow through it. Above all, the higher-boiling oxygen is in this case liquefied from the gas stream, while the lower-boiling nitrogen preferably evaporates out of the liquid drops. Consequently, gaseous nitrogen 32 collects at the cold head of the rectification column 33 and liquid oxygen 36 collects at the warmer bottom.

Downstream of the first rectification stage, the gases are not yet sufficiently pure. For this reason, the liquid oxygen 36 is at least partially evaporated anew in the cold box 31, the gaseous nitrogen is liquefied and both are delivered again to the rectification column 33 where the operation described above is repeated until the desired purity is achieved.

Part of the liquid oxygen 36 is drawn off and stored, and likewise part of the liquid nitrogen 45. After passage through the cold box 31, the following are extracted:
gaseous nitrogen of medium pressure (approximately 11 barg), MP GAN, this previously being further compressed in a compressor,
gaseous oxygen of medium pressure (approximately 9 barg), MP GOX,
gaseous oxygen of high pressure, HP GOX,
gaseous nitrogen of low pressure, LP GAN.

Part of the waste nitrogen 32 from the rectification column 33 is delivered to a nitrogen cooling tower 46 which is cooled by a cooling unit 65. The remaining part of the unpurified nitrogen 32 from the rectification column 33 is delivered to a preheating device 66 and is used for regenerating the adsorbers 29. The hot air from the main air compressor 24, which has discharged the heat to the absorption liquid in the heat exchanger 19, is first cooled and is cooled further in a scrubbing tower 28, in order further to reduce the water vapor content and undesirable gas constituents. Downstream of the adsorber 29 for H₂O/CO₂ removal, the purified air stream 30 is conducted to the cold box 31 and further on to the rectification column 33.

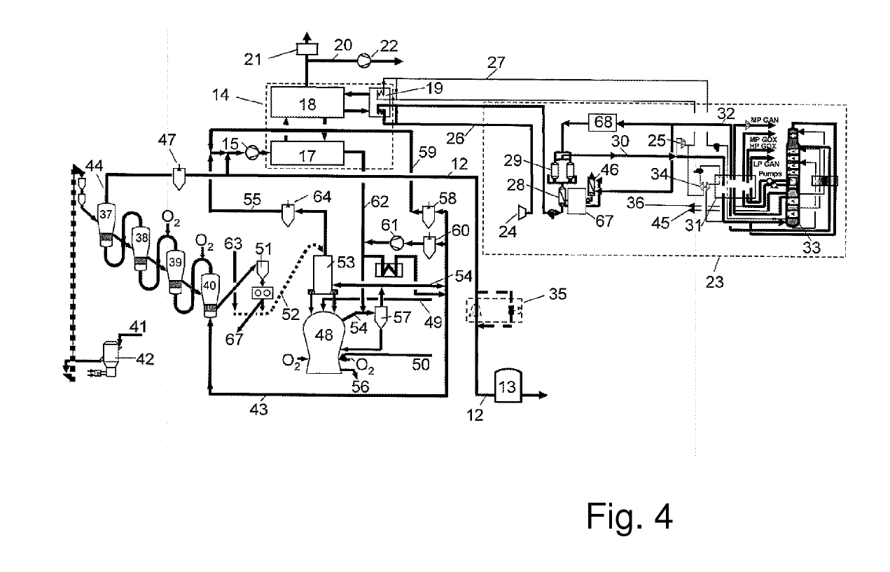

FIG. 4 shows the connection between a plant for melt reduction and an air separation plant 23, according to certain embodiments. The air separation plant 23 is constructed identically to that from FIG. 3, as is the plant 14 for the chemical absorption of CO₂.

The plant for melt reduction, designed as a Finex plant, has, in this example, four reduction reactors 37-40 which are designed as fluidized-bed reactors and are fed with fine ore. Fine ore and additives 41 are delivered to the ore drying facility 42 and from there first to the fourth reactor 37, and they then enter the third 38, the second 39 and finally the first reduction reactor 40. However, instead of four fluidized-bed reactors 37-40, there may even only be three of these present.

The reduction gas 43 is routed in countercurrent to the fine ore. It is introduced at the bottom of the first reduction reactor 40 and emerges on the top side of the latter. Before it enters the second reduction reactor 39 from below, it may also be heated by oxygen O₂, likewise between the second 39 and the third 38 reduction reactor. The exhaust gas 44 emerging from the fourth reduction reactor 37 is purified in a wet scrubber 47 and is used further as export gas 12. A part-stream of the exhaust gas 44 is delivered, according to certain embodiments, to the absorber 17 for CO₂ removal.

The reduction gas 43 is produced in a melt-down gasifier 48, into which, on the one hand, coal in the form of lumpy coal 49 and coal in powder form 50, this together with oxygen O₂, are supplied and into which, on the other hand, the iron ore prereduced in the reduction reactors 37-40 and shaped in the hot state in the iron briquetting 51 into iron briquettes (HCI Hot-Compacted Iron) is added. The iron briquettes in this case pass via a hot conveyor plant 52 into a storage container 53 which is designed as a solid-bed reactor when the iron briquettes are, if appropriate, preheated and reduced by means of coarsely purified generator gas 54 from the melt-down gasifier 48. Here, cold iron briquettes and/or iron oxides (for example, in the form of pellets or lumpy ore) 63 may also be added. Subsequently, the iron briquettes or iron oxides are charged into the melt-down gasifier 48 from above. Low-reduced iron (LRI) 67 may likewise be drawn off from the iron briquetting 51.

The coal in the melt-down gasifier 48 is gasified, and a gas mixture consisting predominantly of CO and H₂ is obtained and is drawn off as reduction gas (generator gas) 54, and a part-stream is delivered as reduction gas 43 to the reduction reactors 37-40.

The hot metal melted in the melt-down gasifier 48 and the slag are drawn off, see the arrow 56.

The generator gas 54 drawn off from the melt-down gasifier 48 is first conducted into a separator 57 in order to separate it from discharged dust and to recirculate the dust via dust burners into the melt-down gasifier 48. Part of the generator gas 54 purified of coarse dust is further purified by means of wet scrubbers 58 and is extracted as excess gas 59 from the Finex plant and, according to certain embodiments, supplied to the absorber 17 of the plant 14 for the chemical absorption of CO₂.

A further part of the purified generator gas 54 is likewise further purified in a wet scrubber 60, delivered for cooling to a gas compressor 61 and then, after being mixed with the product gas 62 extracted from the absorber 17 and freed of CO₂, delivered again for cooling to the generator gas 54 downstream of the melt-down gasifier 48. As a result of this recirculation of the gas 62 freed of CO₂, the reducing fractions contained in it can still be utilized for the Finex method, and, on the other hand, the cooling of the hot generator gas 54 from approximately 1050° C. to 700-870° C. may be ensured.

The top gas 55 emerging from the storage plant 53, where the iron briquettes or iron oxides are heated and reduced by means of dedusted and cooled generator gas 54 from the melt-down gasifier 48, is purified in a wet scrubber 64 and is then likewise delivered to the absorber 17 for the removal of CO₂.

The residual gas 20 downstream of the stripper 18 can again be discharged completely or partially into the atmosphere after H₂S purification 21 or be delivered completely or partially to CO₂ storage after compression by means of the compressor 22.

The export gas 12 can be intermediately stored in an export-gas container 13. An optional expansion turbine 35 serves for utilizing the energy contained in the export gas 12.

The stripper 18 is supplied with preheated absorption liquid which is heated via at least one heat exchanger 19, at the same time discharging the heat of the hot compressed air downstream of the main air compressor 24 or booster air compressor 25, or by means of a heat transfer medium. Just as in FIG. 3, the heat exchanger 19 is fed with at least one hot-gas stream from an air separation plant 23: one gas stream 26 comes from the main air compressor 24 and has a pressure of 5 to 12 bar_{g}, in particular of about 5.2 bar_{g}, and a temperature of about 280° C.; a second gas stream 27 comes from the booster air compressor 25 and has a pressure of 20 to 25 bar_{g}, in particular of 23 bar_{g}, and a temperature of approximately 200° C. Downstream of the booster air compressor 25, the compressed air is compressed to 36 bar_{g}, by means of a turbine-operated compressor 34.

### LIST OF REFERENCE SYMBOLS

1 Blast furnace
2 Sintering plant
3 Oxygen-containing gas
4 Ring line
5 Reduction gas
6 Reduction-gas furnace
7 Slag
8 Pig iron
9 Top gas or blast-furnace gas

10 Dust separator or cyclone
11 Wet scrubber
12 Export gas
13 Export-gas container
14 Plant for the chemical absorption of CO₂
15 Compressor
16 Aftercooler
17 Absorber
18 Stripper
19 Heat exchanger
20 Residual gas downstream of the stripper 18
21 H₂S purification
22 Compressor for the liquefaction of CO₂
23 Air separation plant
24 Main air compressor
25 Booster air compressor
26 Gas stream from the main air compressor 24
27 Gas stream from the booster air compressor 25
28 Scrubbing tower
29 Adsorber
30 Purified air stream
31 Cold box
32 Waste nitrogen from the rectification column 33
33 Rectification column
34 Turbine-operated compressor
35 Expansion turbine
36 Liquid oxygen
37 Fourth reduction reactor
38 Third reduction reactor
39 Second reduction reactor
40 First reduction reactor
41 Fine ore and additives
42 Ore drying facility
43 Reduction gas
44 Exhaust gas from the reduction reactors 37-40
45 Liquid nitrogen
46 Nitrogen cooling tower
47 Wet scrubber for exhaust gas 44
48 Melt-down gasifier
49 Lumpy coal
50 Coal in powder form
51 Iron briquetting (HCI plant)
52 Hot conveyor plant
53 Storage container designed as a solid-bed reactor for the preheating and reduction of iron oxides and/or iron briquettes
54 Generator gas from the melt-down gasifier 48
55 Top gas from the wet scrubber 64
56 Hot metal and slag
57 Separator for fine ore
58 Wet scrubber
59 Excess gas
60 Wet scrubber
61 Gas compressor
62 Gas freed of CO₂ from the absorber 17
63 Cold iron briquettes or oxide materials
64 Wet scrubber
65 Cooling unit
66 Preheating device
67 Low-reduced iron (LRI)

What is claimed is:

1. A method for the removal of CO₂ from exhaust gases of a pig-iron production plant or a synthesis-gas plant, comprising:
removing the CO₂ using at least one of chemical absorption process and a physical absorption process using an absorbent,
conducting hot air from an air separation plant into a heat exchanger for heating and regenerating the absorbent, wherein air is cooled in the heat exchanger, and
recirculating the air cooled in the heat exchanger for cooling and purifying into a scrubbing tower and an absorber of the air separation plant.

2. The method of claim 1, wherein the absorbent used is potassium carbonate.

3. The method claim 1, further comprising an amine scrub.

4. The method of claim 3, wherein one or more primary amines, including at least one of methylamine, monoethanolamine (MEA), and diglycolamine (DGA), are used.

5. The method of claim 3, wherein one or more secondary amines, including at least one of diethanolamine (DEA) and diisopropanolamine (DIPA), are used.

6. The method of claim 3, wherein one or more tertiary amines, including at least one of triethanolamine (TEA) and methyldiethanolamine (MDEA), are used.

7. The method of claim 1, wherein top gas from an oxygen blast furnace with top-gas recirculation is purified of CO₂.

8. The method of claim 1, comprising purifying-exhaust gas from a melt-reduction plant.

9. The method of claim 8, comprising purifying at least one of the following exhaust gases:
exhaust gas from a melt-down gasifier,
exhaust gas from at least one reduction reactor, and
exhaust gas from at least one solid-bed reactor for preheating and reduction of at least one of iron oxides and iron briquettes.

10. The method of claim 1, wherein at least part of the purified exhaust gas is used again as a reduction gas for pig-iron production.

11. The method of claim 1, wherein a heat transfer medium from the air separation plant is conducted into a heat exchanger for heating and regenerating the absorbent.

12. The method claim 11, wherein hot air from at least one of a main air compressor and a booster air compressor is used by the heat transfer medium.

13. The method of claim 1, wherein the CO₂-rich gas obtained from the 00₂ removal process is used as a substitute gas in an iron production process or for treatment and storage of CO₂.

14. An apparatus for removing CO₂ from exhaust gases of a pig-iron production plant or a synthesis-gas plant, comprising:
a plant for removing CO₂ from exhaust gases using at least one of a chemical absorption process and a physical absorption process using an absorbent,
wherein a part of the plant for regenerating the absorbent is connected to an air separation plant, such that heat generated therein is used for regenerating the absorbent,
at least one line configured to conduct hot air from the air separation plant into a heat exchanger for heating and regenerating the absorbent, and
at least one line for recirculating air cooled in the heat exchanger for cooling and purifying into a scrubbing tower and an absorber of the air separation plant.

15. The apparatus of claim 14, comprising a line configured to conduct top gas from a an oxygen blast furnace with top-gas recirculation into the plant for the removal of CO₂ by at least one of chemical absorption -and physical absorption.

16. The apparatus of claim 14, comprising at least one line configured to conduct exhaust gas from a melt-reduction plant the plant for the removal of CO₂ by at least one of chemical absorption and physical absorption.

17. The apparatus of claim 16, wherein at least one lines is connected to at least one of the following devices:
a melt-down gasifier,
one or more reduction reactors,
a solid-bed reactor for the preheating and reduction of at least one of iron oxides and iron briquettes.

18. The apparatus of claim 14, characterized in comprising a line configured to conduct at least part of the purified exhaust gas back again as a reduction gas for pig-iron production.

19. The apparatus of claim 14 comprising at least one line configured to conduct hot air or another heat transfer medium from the air separation plant is a heat exchanger for heating and regenerating the absorbent.

20. The apparatus of claim 19, comprising at least one line configured to conduct hot air or another heat transfer medium from at least one of a main air compressor and a booster air compressor into the heat exchanger.

21. The apparatus of claim 14, wherein the plant for the removal of CO₂ is connected to at least one of a plant for pig-iron production and a plant for the treatment and storage of CO₂, such that CO₂-rich gas obtained is used as a substitute gas in at least one of an iron production process and a process for treatment and storage of CO₂.
